(19) United States
(12) Patent Application Publication
(10) Pub. No.: US 2022/0219800 A1
(43) Pub. Date: Jul. 14, 2022

(54) RAPID AIR BALLAST SYSTEM FOR AN AIRSHIP

(71) Applicant: NEFF AERONAUTICS, LLC, Sandy, UT (US)

(72) Inventors: William J. Neff, Sandy, UT (US); Daniel Rovey, Talkeetna, AK (US); Adam Black, Ogden, UT (US); Robert Neff, Colorado Springs, CO (US); Rick Neff, Malta, ID (US)

(73) Assignee: Neff Aeronautics, LLC, Sandy, UT (US)

(21) Appl. No.: 17/146,249

(22) Filed: Jan. 11, 2021

(51) Int. Cl. B64B 1/70; B64B 1/62

(52) U.S. Cl. CPC B64B 1/70; B64B 1/66; B64B 1/62

(57) ABSTRACT

A Rapid Air Ballast System that generates ballast for an airship relatively quickly by compressing air at low pressures into a ballonet inside a large volume tank. The air pressure inside the ballonet being roughly equal to the lifting gas pressure outside the ballonet but inside the tank. The system comprising a controllable air compression device to achieve the desired air pressure and valves in the system to direct the flow of air into or out of the system. This is particularly useful for quickly and efficiently controlling aerostatic lift for an airship, especially while performing on-loading and off-loading of payload operations.

### FIELD OF THE INVENTION

This disclosure relates to a system designed to readily change the weight of an airship by compressing or releasing air. The system uses a large volume tank so that low pressure reduces compression time and energy. The system compensates for the weight of cargo that is picked up or off loaded. It provides altitude control at zero airspeed. The constant volume tank also creates altitude stability. Air ballast is advantageous because it is always available and easily released.

### BACKGROUND OF THE INVENTION

Currently, the primary challenge for cargo airships is ballast or buoyancy management. Maintaining altitude after dropping off 30 tons of cargo means an airship must increase weight by 30 tons or reduce static lift by 30 tons. A practical solution for this problem has not been demonstrated in flight.

A secondary challenge for airships is altitude control at zero airspeed. Airship lifting gas has always been at ambient pressure, or at a slight offset above ambient pressure. This means that lifting gas expands as altitude increases, so that aerostatic lift does not change with altitude. Altitude control strategies include dropping ballast, venting lifting gas, thrust vectoring, and aerodynamic lift. Reliance on aerodynamic lift means that airships use airplane style shallow approach paths dependent on airspeed to control altitude. Lacking altitude control without airspeed, airships rely on thrust vectoring for hovering. Without power, airships climb until lifting gas is vented or descend until ballast is dropped. The use of aerodynamic lift and thrust vectoring requires energy, which if it is provided by a combustion engine increases fuel burn and CO₂ emissions.

Air weight can be useful ballast for an airship. Previous designs considered tanks with small volume and high pressure. High pressure air ballast requires significant time and energy for compression. Compression time greater than an hour is a significant impact on the practical use of a cargo airship.

Rapid ballast capability is useful for hovering cargo deliveries. Reducing the time required for delivery reduces exposure to challenging wind gusts.

A fast and efficient ballast system is desirable. The disclosed system is fast and efficient because of the large volume and low pressure involved in controlling altitude and compensating for cargo and fuel weight.

### SUMMARY

The following implementations and aspects thereof are described and illustrated in conjunction with systems, machines, and methods that are meant to be exemplary and illustrative, not necessarily limiting in scope. In various implementations one or more of the above-described problems have been addressed, while other implementations are directed to other improvements.

Beneficially, the “Rapid Air Ballast System” according to the invention disclosed herein allows for air to be relatively quickly compressed into a large volume low pressure container to add desired ballast. The large volume container or tank may consist of aluminum, carbon fiber composite, or any lightweight material capable of containing the desired pressure. A controllable valve releases the pressure when less ballast is desired.

The invention advantageously uses an efficient system where the energy required for air compression will be minimized by using large volume and low pressure.

The invention is implemented as a large tank filled with lifting gas and the tank containing a ballonet that separates the lifting gas from the air. The ballonet is designed to freely change volume, so that air and lifting gas are at the same effective pressure. The ballonet fabric does not require significant strength because of the equivalent pressure of the air and lifting gas. The ballonet volume might be roughly one third of the entire tank volume. Distributing pressure to the lifting gas keeps the pressure low by taking advantage of the entire tank volume. Filling the main pressure tank volume with lifting gas instead of air significantly decreases the weight of the airship. Ballonets have been used in previous airships to maintain pressure within the strength capability of fabric envelopes. This invention uses a ballonet for significant ballast capability, which is a new application.

Firstly, in various embodiments, the large tank may act as the outside body of the airship like a metal-skinned airship.

Secondly, in various embodiments the invention may act as the hull of the airship, where the bottom section of the airship may be a pressure tank filled with lifting gas, with a fabric ballonet separating air from the lifting gas. The top section of the airship may be a fabric envelope containing unpressurized lifting gas. Keeping the fabric envelope unpressurized minimizes weight, cost, and complexity, but it does require battens, or structural reinforcement to keep the nose of the envelope from caving inward under dynamic pressure. This lightweight fabric top section has a low weight to static lift ratio due to the lightness of the fabric compared to the volume of lifting gas it holds while the bottom pressure tank section has a higher weight to static lift ratio due to the weight of the pressure tank skin.

Additionally, in various embodiments, this air ballast system allows control of altitude at zero airspeed, vertical takeoff and landing, and hovering cargo exchange using a vertical lift winch. The system is scalable to large cargo airships and does not use vertical thrust vectoring. The constant volume pressure tank combined with the ability to increase or decrease weight provides altitude control at zero airspeed. Pressurized air is released to reduce weight and climb. Air is compressed into the ballonet to increase weight and descend. Compressed air also replaces the weight of cargo delivered, whether the airship lands on the ground or hovers and sets cargo down with a hoist. Without power, this airship will remain at its equilibrium altitude, with the option of controlled climb by releasing air pressure.

This Rapid Air Ballast System uses a [symbol] constant volume pressure tank. This is distinctly different from previous airships because a significant portion of lifting gas is contained in the constant volume tank. For the Rapid Air Ballast System, that constant volume provides altitude control because the weight of the airship determines the equilibrium altitude. Previous airships use lifting gas at ambient pressure or at a slight offset (0.2 PSI or less) from ambient pressure. That means that lifting gas volume changes with altitude, so that static lift does not change with altitude. That variable volume characteristic means that airships could not control altitude without thrust vectoring or airspeed for aerodynamic lift.

The Rapid Air Ballast System provides altitude stability for the airship. This airship will have an equilibrium altitude based on its weight and volume. If something moves the airship up or down, the airship will move back toward the equilibrium altitude. If the airship desires to increase altitude it would release air from the ballonet in the constant volume pressure tank until it reached its new desired altitude. Previous airships had no tendency to return to an original altitude, because static lift does not change with altitude.

The Rapid Air Ballast System does not require power to take off or climb. Descending requires energy (e.g., fuel or batteries) for air compression, but the low pressure required to add sufficient weight makes it efficient. A fully loaded airship optimizes descent efficiency because pressure is minimized by minimizing the weight of air ballast in the tank. Lower pressure reduces compression energy. Heavier cargo requires less energy to descend. This application provides economic and environmental benefits gained from this efficiency. The Rapid Air Ballast System airship provides round trips to altitude and back down with fuel costs and greenhouse gas emissions that are extremely low.

These and other advantages will become apparent to those skilled in the relevant art upon a reading of the following descriptions and a study of the several examples of the drawings.

### BRIEF DESCRIPTION OF THE DRAWINGS

The present invention can be put into practice in various ways, but embodiments will now be described by way of example only with reference to the accompanying drawings in which:

FIG. 1 shows an illustrative embodiment of the Rapid Air Ballast System where the tank constitutes the lower section of an airship which also comprises a fabric envelope on the upper section of an airship.

FIG. 2 shows an illustrative embodiment of the interior of the tank comprising the Rapid Air Ballast System showing possible arrangement of ballonets and tethering to prevent ballonets becoming entangled.

FIG. 3 shows an illustrative embodiment of the interior of the tank comprising the Rapid Air Ballast System showing possible arrangement of ballonets in the inflated position.

FIG. 4 shows a matrix of operations for the Rapid Air Ballast System inflating and deflating the ballonet to control buoyancy.

### DETAILED DESCRIPTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, any claims herein are not to be limited to that embodiment. Moreover, any such claims are not to be read restrictively unless there is clear and convincing evidence manifesting a certain exclusion, restriction, or disclaimer.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art.

One or more embodiments of a system wherein air is added into ballonets that are inside a large volume tank of lifting gas, the compression of air being accomplished by a standalone air blower, air compressor, CO₂ cartridges, or as part of the engine of a turbofan, or otherwise, in order to quickly and efficiently put air into the ballonet.

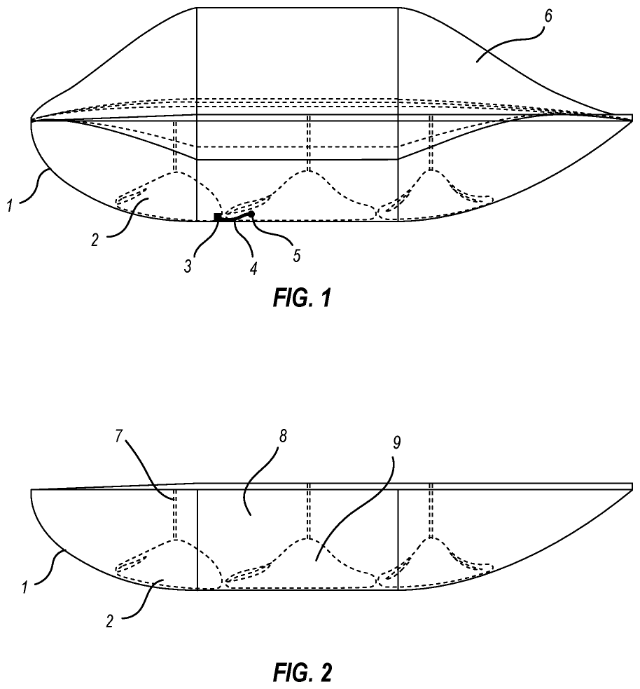

FIG. 1 is depicting one possible configuration of an illustrative embodiment of the Rapid Air Ballast System comprising 1. a large pressure tank with 2. ballonets inside that are capable of holding compressed air and keeping the air inside the ballonet separate from the lifting gas outside the ballonet and 3. an air compressor device capable of providing power to achieve the desired air pressure inside the tank and delivering the air into the tank via 4. hoses, pipes, or other plumbing apparatus and having 5. a valve that controls the airflow into and out of the ballonet. This depiction shows the Rapid Air Ballast System as the lower section of an airship which also comprises 6. a fabric envelope on the upper section of an airship.

FIG. 2 is depicting one possible configuration of an illustrative embodiment of the Rapid Air Ballast System comprising 1. a large pressure tank with 2. ballonets 7. tethered to the tank in such a way as to prevent entanglement of the ballonet with itself or surrounding features. The 8. lifting gas inside the tank being the same pressure as the 9. compressed air inside the ballonet.

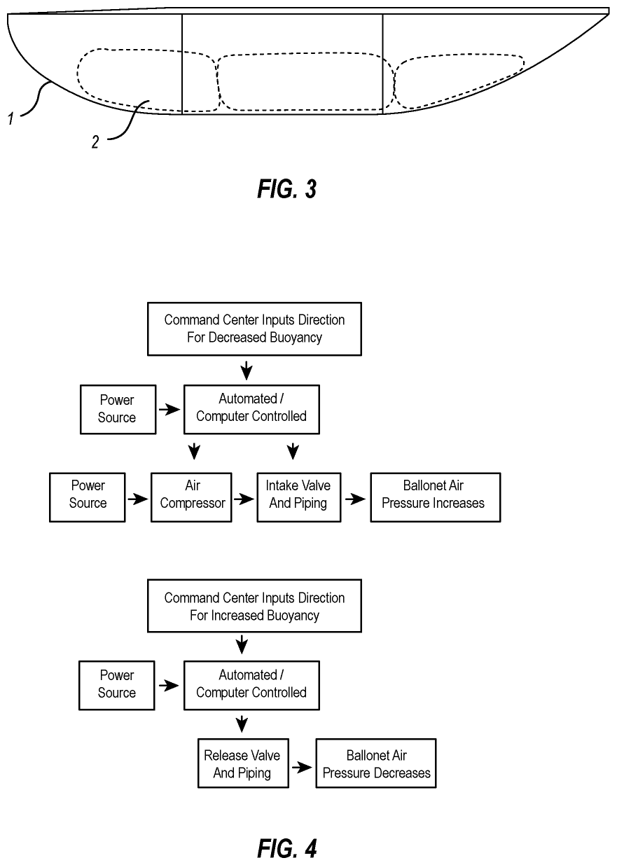

FIG. 3 is depicting one possible configuration of an illustrative embodiment of the Rapid Air Ballast System comprising 1. a large pressure tank with 2. Ballonets that are shown in the inflated position.

FIG. 4 shows a matrix of operations for the Rapid Air Ballast System inflating and deflating the ballonet to control buoyancy. Upon command to adjust the buoyancy, which may be given by a manned-operator or autonomously through a computer operated system, an electronic control system will start the air compressor and open the intake valve, if required, to begin to compress air into the ballonet. Whereby, said compressed air pressure being heavier than the lifting gas causes the overall system to be heavier. Or if command is for an increase in buoyancy the operator system directs the electronic control system to release the valve in a controlled manner that allows the air pressure in the ballonet to decrease to a desired level. Whereby, said decreased pressure removes the weight of the compressed air causing the overall system to be lighter.

1. A Rapid Air Ballast System that generates ballast for an airship relatively quickly by adding air at low pressures into a ballonet inside a large volume tank. The system comprising a controllable air compression device to achieve the desired air pressure and piping and valves in the system to direct the flow of air into or out of the system.

2. The Rapid Air Ballast System according to claim 1, wherein the tank is a lightweight material capable of containing the desired pressure.

3. Wherein the tank material is selected from the group selected from aluminum, titanium, carbon fiber, or other lightweight metal, material, or composite.

4. The Rapid Air Ballast System according to claim 1, wherein the ballonet separates the compressed air inside the ballonet from the lifting gas in the tank outside of the ballonet.

5. The Rapid Air Ballast System according to claim 1, wherein the ballonet is tethered or suspended in such a way as to prevent entanglement of the ballonet.

6. The Rapid Air Ballast System according to claim 1, wherein the tank is the body of the airship.

7. The Rapid Air Ballast System according to claim 1, wherein the tank is only a portion of an airship and a fabric envelope containing lifting gas provides additional buoyancy.

8. The Rapid Air Ballast System according to claim 1, wherein the tank has operation systems attached to it sufficient for an operational airship.

9. Wherein the operation systems are selected from the group selected from engines, propellers, wings, fins, elevator, rudders, cargo bay, doors, ramps, hoists, winches, gondola, maintenance facilities, and crew and passenger quarters.

10. The Rapid Air Ballast System according to claim 1, wherein the tank has areas for securing it (e.g., affixing tie-down tethers to a runway, anchored to the ground, ocean floor, moored to a mast) to maintain its general vicinity.

11. The Rapid Air Ballast System according to claim 1, wherein the controllable air compression device is a standalone air blower or air compressor.

12. The Rapid Air Ballast System according to claim 1, wherein the controllable air compression device is part of an engine.

13. The Rapid Air Ballast System according to claim 1, wherein there are pipes and valves that control the direction of air flow into and out of the ballonet.

14. The Rapid Air Ballast System according to claim 1, wherein the airship has the ability to attach itself to other airships in a train-like formation.

15. The Rapid Air Ballast System according to claim 1, wherein airships attached in a train-like formation have one continuous runway or cargo area from which to conduct aircraft operations.
